(19) United States
(12) Patent Application Publication
(10) Pub. No.: US 2016/0264082 A1
(43) Pub. Date: Sep. 15, 2016

(54) LIGHT-WEIGHT ENERGY ABSORPTION ASSEMBLY FOR A VEHICLE IMPACT SYSTEM

(71) Applicant: GM GLOBAL TECHNOLOGY OPERATIONS LLC, Detroit, MI (US)

(72) Inventors: Elisabeth J. BERGER, Farmington Hills, MI (US); Vinayshankar L. VIRUPAKSHA, Troy, MI (US); Jeanne C. POLAN, Shelby Township, MI (US)

(73) Assignee: GM GLOBAL TECHNOLOGY OPERATIONS LLC, Detroit, MI (US)

(21) Appl. No.: 14/657,980

(22) Filed: Mar. 13, 2015

(51) Int. Cl. B60R 19/22; B29C 44/56; B60R 19/03

(52) U.S. Cl. CPC B60R 19/22; B60R 19/03; B29C 44/5681; B60R 2019/1873

(57) ABSTRACT

A light-weight, high-strength energy absorption assembly is provided. Open cells of a reinforced composite web are filled with an energy absorbing material that defines energy absorbing cells within the web to provide a composite structure. A front component is disposed on a front side of the composite structure and a back component is disposed on a back side of the composite structure to provide an energy absorption assembly having a predetermined distribution profile. The light-weight, high-strength energy absorption assembly may be used in a variety of applications, including vehicle or automotive components, such as part of a bumper assembly.

### FIELD

The present disclosure relates to the predetermined distribution of an impact load, particularly in vehicles.

### BACKGROUND

This section provides background information related to the present disclosure which is not necessarily prior art.

There is a continual need to reduce the mass of vehicle components for improved fuel efficiency. There is a corresponding need, however, that components of automobiles or other vehicles are able to manage the loads applied both during normal vehicle service and under extraordinary conditions, such as collisions. There is, therefore, a need for a light-weight vehicle component capable of managing the load applied both during normal vehicle service and under extraordinary conditions such as collisions.

### SUMMARY

This section provides a general summary of the disclosure and is not a comprehensive disclosure of its full scope or all of its features.

In certain aspects, the present disclosure contemplates a method of producing an energy absorption assembly. The method comprises introducing an energy absorbing material into a plurality of open cells defined by a web, so as to form a composite structure comprising the web and a plurality of energy absorbing cells retained therein. A front component is then disposed on a front side of the composite structure. A back component is then disposed on a back side of the composite structure. The composite structure, together with the front component and back component, form the energy absorption assembly.

In other aspects, the present disclosure contemplates a light-weight energy absorption assembly. The light-weight energy absorption assembly includes a web that defines a plurality of cells, which are filled with a light-weight energy absorbing material. The web and filled plurality of cells together define a composite structure. A front component is disposed on a front side of the composite structure. A back component is disposed on a back side of the composite structure. The composite structure, together with the front component and the back component, form the light-weight energy absorption assembly. The light-weight energy absorption assembly has properties such that a force applied to the front plate is distributed across the light-weight composite energy absorption assembly along a predetermined distribution profile.

In yet other aspects, the present disclosure contemplates a method of producing an energy absorption assembly. The method comprises introducing an energy absorbing material into a plurality of open cells defined by a web, so as to form a composite structure comprising the web and a plurality of energy absorbing cells retained therein. A front component is then disposed on a front side of the composite structure. A back component is then disposed on a back side of the composite structure. The energy absorption assembly has properties such that a force applied to the front plate is distributed across the light-weight composite energy absorption assembly along a predetermined distribution profile.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a bumper assembly with the energy absorption assembly for a vehicle according to the present disclosure.

FIG. 2 is a perspective view of an exploded view of an energy absorption assembly according to certain aspects of the present disclosure with the front component and back component separated from the composite structure.

FIG. 3 is a perspective view of an exploded reinforced composite web.

FIG. 4 is a front view of a reinforced composite web having a plurality of open cells with one of the open cells being filled with an energy absorbing cell according to certain aspects of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “front,” “back,” “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. If, for some reason, the imprecision provided by “about” is not otherwise understood in the art with this ordinary meaning, then “about” as used herein may indicate a possible variation of up to 5% of the indicated value or 5% variance from usual methods of measurement.

As used herein, the term “composition” refers broadly to a substance containing at least the preferred metal elements or compounds, but which optionally comprises additional substances or compounds, including additives and impurities. The term “material” also broadly refers to matter containing the preferred compounds or composition.

In addition, disclosure of ranges includes disclosure of all values and further divided ranges within the entire range, including endpoints and sub-ranges given for the ranges.

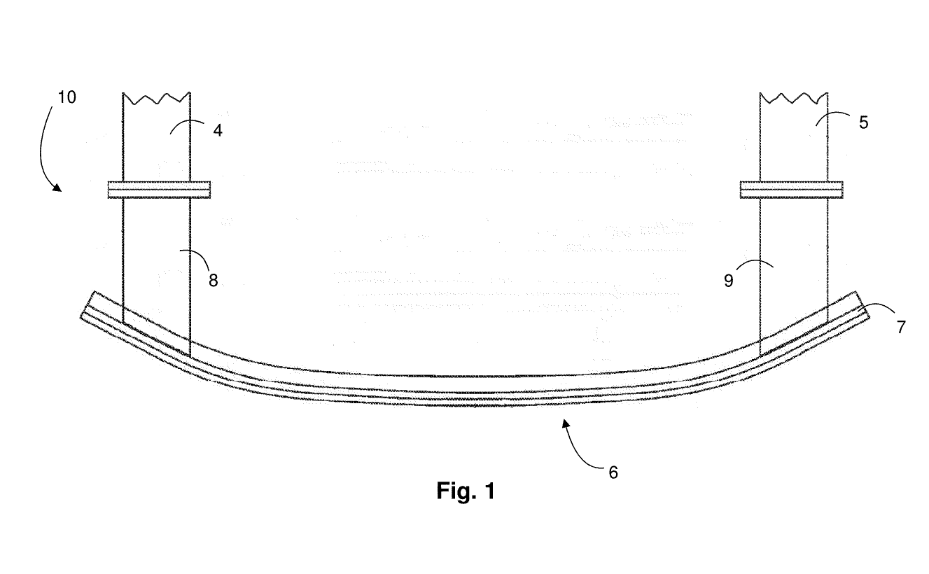

The present disclosure provides methods of producing light-weight high strength composite energy absorption assemblies and composite energy absorption assembly products. Referring to FIG. 1, in various embodiments, the methods and products are directed to bumper assemblies 10 for vehicles. Notably, the composite energy absorption assemblies are particularly suitable for use in components of an automobile or other vehicles (e.g., motorcycles, boats), but may also be used in a variety of other industries and applications, including aerospace components, industrial equipment and machinery, farm equipment, heavy machinery, by way of non-limiting example. While reference will be made herein to automotive bumper assemblies, it should be noted that while the light-weight high-strength composite energy absorption assemblies provided by the present disclosure are particularly well suited for such applications, they may also be used to form other automotive structural components. Non-limiting examples include pillars, such as hinge pillars, panels, including structural panels, door panels, and door components, interior floors, floor pans, roofs, exterior surfaces, underbody shields, wheels, storage areas, including glove boxes, console boxes, trunks, trunk floors, truck beds, lamp pockets and other components, shock tower cap, control arms and other suspension, undercarriage or drive train components, and the like. Specifically, the present disclosure is particularly suitable for any piece of hardware subject to loads or impact (e.g., load bearing).

Regarding automobile bumper assemblies, the disclosed methods and products can be used equally in a front or a rear bumper. Crush members (e.g., crush cans) 8 and 9 may be installed as part of the bumper assembly 10. The bumper assembly 10 further includes a frame structure, such as vehicle rails 4 and 5. In such bumper assemblies, crush members 8 and 9, respectively, connect the bumper 6 having an energy absorption assembly 7 to the vehicle rails 4 and 5. Each of the vehicle rails 4 and 5 can comprise aluminum or other metals, for example. While not shown, the bumper assembly 10 is exemplary and may further include other components, such as a decorative fascia.

As discussed in further detail herein, the energy absorption assembly 7 according to certain variations of the present disclosure is a one-piece, unitary component capable of distributing a force along a predetermined profile. As a non-limiting example, as used in a bumper assembly 10, the energy absorption assembly 7 generally spans a width sufficient to distribute energy across the energy absorption assembly 7 in the event of an impact. In certain variations, the width of the energy absorption assembly is at least as long as the distance between vehicle rails 4 and 5.

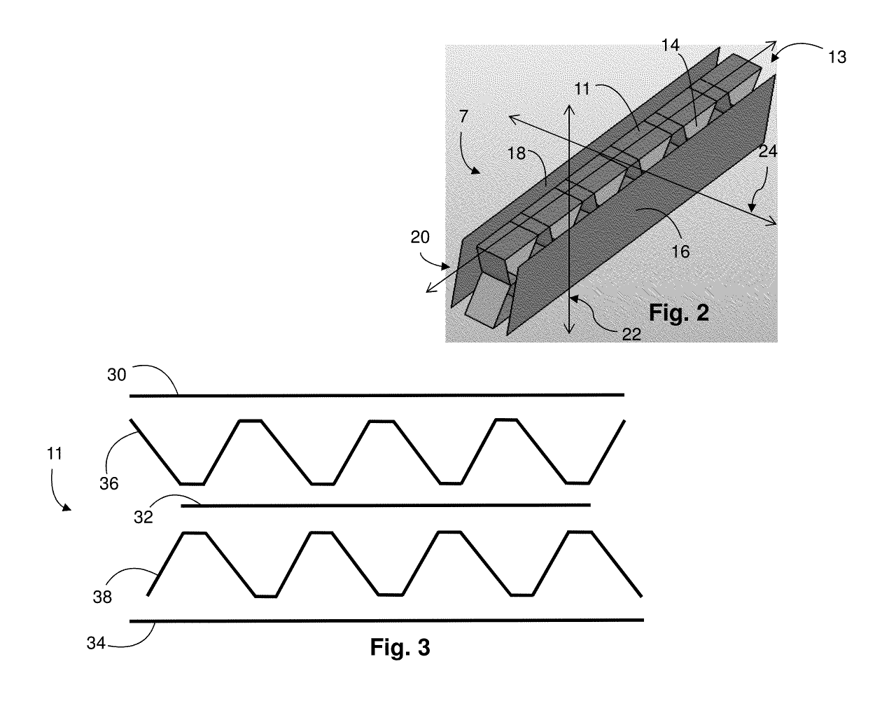

Referring to FIGS. 2 and 3, the energy absorption assembly 7 is comprised of a reinforced composite web 11 and a plurality of open cells 12 at least one of which is filled with an energy absorption material to form one or more energy absorbing cells 14 that together with the reinforced composite web 11 form composite structure 13. The energy absorption assembly further includes a front component 16 and a back component 18. Energy may be distributed across the reinforced composite web 11 of the energy absorption assembly. In various aspects, the energy may be distributed lengthwise along a width (represented by line 20) 20, along a height (represented by line 22) 22, or along a back-to-front direction (represented by line 24) 24. Ideally, the energy is distributed along a width 20, along a height 22, and along a back-to-front direction 24 in a predetermined fashion. In certain aspects, the greatest energy input may be in the back-to-front direction 24. In other aspects, the energy may be distributed across the energy absorption assembly 7 to the crush members 8 and 9.

The web may comprise aluminum or steel, and, in various, preferred aspects, the web is a reinforced composite web comprising a polymeric matrix having a reinforcing material distributed therein. A particularly suitable reinforcing material distributed therein is formed from non-crimp fabric (“NCF”) carbon or glass fibers, which, due to higher strength in compression pathways, allows for a better distribution profile should an impact occur. Other non-limiting examples of reinforcing materials for forming the reinforced composite web include glass fiber, carbon fiber, aramid fiber (such as KEVLAR™ para-aramid fiber, commercially available from DuPont), basalt fiber, fiber made from natural products such as hemp, jute, or other bast fibers, high strength polymeric fibers, such as high strength polyethylene or high strength polypropylene. The reinforcing materials may be fabricated as woven fabric, continuous random fabric, chopped random fabric, continuous strand unidirectional plies, oriented chopped strand plies, braided fabric and any combinations thereof.

The reinforced composite web may be formed via pultrusion. In such instances, continuous fibers are pulled into a resin wet out bath where the fibers are saturated with a liquid resin. The resin is typically selected from thermosets or thermoplastics. Suitable thermosets include thermoset polyester, polyurethane, or epoxy, while suitable thermoplastics include thermoplastic polyester, polyurethane, or polyolefin. Preferably, the resin is a vinyl ester. Thus, the resin may be selected from the group consisting of polyester, polyurethane, epoxy, vinyl ester, polyolefin, and combinations thereof. The fibers are then drawn from the bath through a squeeze out die, which controls the fiber to resin ratio, and into a heated final forming die where the thermo-setting resin hardens and cures. The solid composite is pulled out of the final forming die by in-line pulling units which grip the composite and work in tandem to pull material through the entire continuous process. The composite is sheared into predetermined forms or lengths, as desired. When thermoplastic and/or thermosets resins are used, the resins may be injected into the heated final forming die. Thus, the resin can also be injected into the forming die, which is particularly to be used for thermoplastic pultrusion but sometimes for thermoset based pultrusion.

Pultrusion may be particularly advantageous as it allows for the reinforced composite web to be formed in its entirety in one pultrusion processing step. Alternatively, the individual parts comprising the reinforced composite web may be pultruded and later fused together. Referring to FIG. 3, flats 30, 32, and 34 and chains 36 and 38 may be formed separately. Subsequent thereto, flats 30 and 32 are joined to chain 36 and flats 32 and 34 are joined to chain 38. In such embodiments, the flats and chains comprising the reinforced composite web may be joined via adhesive bonding, mechanical fastening (e.g., via mechanical attachments such as rivets), or, where the reinforced composite web is comprised of a thermoplastic, ultrasonic or vibrational welding.

Alternatively, the flats and chains comprising the reinforced composite web may be formed by compression molding, and joined via adhesive bonding, mechanical fastening, or, where the flats and chains comprise thermoplastic materials, ultrasonic or vibrational welding. In yet other embodiments, the flats and chains comprising the reinforced composite web may be formed by autoclave molding, vacuum molding, resin transfer molding, structural resin transfer molding, or other composite molding techniques. The flats and chains are subsequently joined via mechanical fastening, adhesive bonding, or ultrasonic or vibrational welding if appropriate. Such forming steps, including pultrusion, may yield a curved reinforced composite web profile, particularly if the parts are fabricated in large units which can be joined (if not pultruded as one piece) and then cut to a curved or other profile, as seen from a lengthwise axis of height 22.

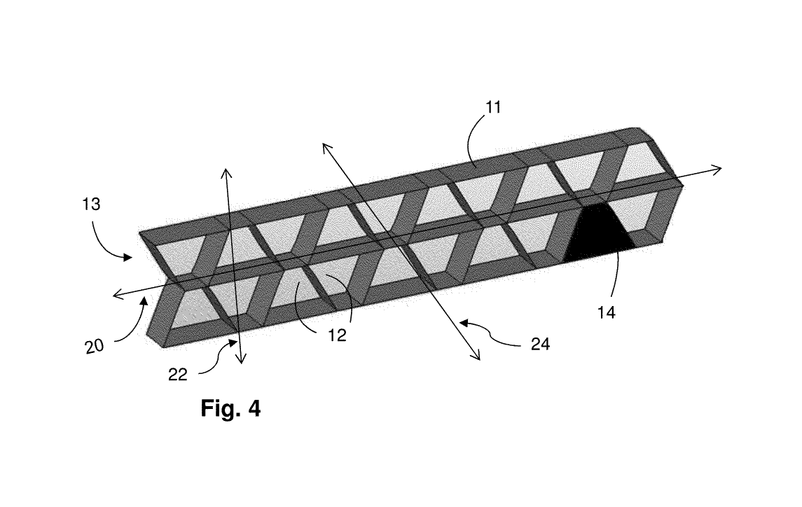

Referring to FIG. 4, an energy absorbing material is introduced, into at least a cell of the plurality of open cells 12 of the reinforced composite web 11 to form at least one energy absorbing cell 14. The energy absorbing material may be introduced by forming in situ or by inserting the energy absorbing material into the respective open cell. Every open cell 12 may be filled with the energy absorbing material to form a plurality of energy absorbing cells. In some embodiments, only select open cells 12 are filled with energy absorbing material. In some embodiments, the plurality of cells has a uniform shape. In other aspects, the plurality of cells has uniform volume. In yet other aspects, the plurality of cells has uniform shapes and volumes. The uniform shapes may have shapes consisting of trapezoidal shapes, triangular shapes, squares, rectangles, parallelograms, hexagonal shapes, and the like. In yet other aspects, there may be cells of different shapes and volumes within the same reinforced composite web. Preferably, reinforced composite web 11 has less than or equal to about 20 cells and greater than or equal to 10 cells, although more cells can also be envisioned.

In yet other aspects, the cells comprise a first cell having a first volume and a second cell having a second volume, wherein the first volume is distinct from the second volume. As non-limiting examples, in some embodiments, the reinforced composite web may have larger or longer cells in select areas, for example, within an area towards the center of the reinforced composite web, and shorter or smaller cells in the terminal lateral areas of the reinforced composite web. In yet other variations, the cells are smaller (and thus greater in cell density) in the center of the reinforced composite web to provide better energy absorption in the event of a front-side accident. In yet other variations, a first cell may be filled with a first energy absorbing material and a second cell may be filled with a second energy absorbing material distinct from the first energy absorbing material.

Referring again to FIG. 4, at least one of the open cells is filled with an energy absorbing material to form a corresponding energy absorbing cell 14. Suitable energy absorbing materials can be selected from the group consisting of expanded polypropylene, expanded aluminum (e.g., sintered aluminum or aluminum honeycomb), hybridized polyethylene/polyolefin resin, balsa wood and mixtures thereof, by way of non-limiting example. The energy absorbing material can be selected from any other materials having impact damage protection applications. The energy absorbing material is typically light weight.

The energy absorbing material may be formed in situ by introducing a precursor of the energy absorbing material within the open cells 12 of the reinforced composite web 11. By way of example, the precursor of the energy absorbing material may be introduced in combination with a foaming agent. As one example, non-expanded polypropylene beads may be placed in one or more open cells 12 of the formed reinforced composite web 11. The reinforced composite web 11 may be placed in a steam press mold to which high pressure steam will be introduced, causing the polypropylene beads to expand to fill the one or more open cells 12 so that the reinforced composite web has at least one energy absorbing cell formed of foam.

In yet other aspects, the energy absorbing material may be pre-formed into a shape with dimensions appropriate to fit within a cell of the plurality of open cells and is subsequently inserted into the corresponding cell of the reinforced composite web. In all aspects, the density of the energy absorbing material may be controlled to provide a predetermined distribution profile. Controlling the density of the energy absorbing material provides a predetermined distribution profile by controlling the pounds per cubic foot (PCF) of the energy absorbing material. When the energy absorbing material comprises EPP, suitable densities of the energy absorbing material provide PCF ranging from about greater than or equal to 1.8 to less than or equal to about 14. In automotive applications, the predetermined distribution profile is generally selected depending on the type of automobile, the zone of the energy absorption assembly on which impact is contemplated, and/or to comply with applicable country or other regulations.

Referring again to FIG. 2, a front component 16 at least partially covers a front side of composite structure 13 and a back component 18 at least partially covers a back side of composite structure 13. It should be noted that “front” denotes a direction from which impact force is most likely to come, while “back” is used to indicate the side that attaches to the crush cans, although these terms are only used for nominative non-limiting purposes.

The front component 16 may be formed of a reinforced composite, with reinforcement of at least one of a carbon fiber, a glass fiber, an aramid fiber (such as KEVLAR™ para-aramid fiber), or a natural fiber, as well as mixtures thereof. The front component may be prepared by pultrusion, compression molding, or the like.

The back component 18 may be formed of at least one of a carbon fiber, a glass fiber, an aramid fiber (such as KEVLAR™ para-aramid fiber), or a natural fiber, as well as mixtures thereof. The back component may be prepared by pultrusion, compression molding, or the like. Back component 18 may further be attached to crush members 8 and 9. The attachment may be structured so as to avoid peel between the composite structure 13 and the back component 18. To facilitate this, a lip at 90° to an axis of back-to-front direction 24 would be molded or otherwise fastened onto the front or back of reinforced composite web 11 or the top or bottom of front component 16 or the back component 18, in order to allow more secure attachment of front component 16 or back component 18 to reinforced composite web 11. While not shown, the attachment may be a mechanical peel stopper, and may be comprised of rivets punched through at least a portion of composite structure 13 and back component 18. The attachment may also be joined to the reinforced composite web 11 by adhesive bonding, or, where the attachment surfaces comprise thermoplastics, ultrasonic welding or vibrational welding. The attachment may be secured around areas where peel is more likely, such as around a crush member. In yet other embodiments, a crush member (e.g., 8 and/or 9) may extend from the vehicle rails 4 and 5 into one of the plurality of cells, allowing joining through the cell walls of reinforced composite web 11. KEVLAR™ para-aramid fiber, commercially available from DuPont, with its higher elongation, may facilitate the back component 18 remaining attached to the crush members 8 and 9 and the reinforced composite web 11 upon impact. In other variations, the higher modulus or strength of carbon or glass fibers would be preferred.

In yet other embodiments, the energy absorbing assembly includes multiple composite structures that are attached to one another. More specifically, there may be at least two distinct composite structures in the assembly, where a back side of a first composite structure is in contact with a front side of a second composite structure. In some aspects, the iteration of cells in the first composite structure is different from the iteration of cells in the second composite structure. Further, the first composite structure may be overlapping or staggered against the second composite structure such that the cells of each composite structure are overlapping with each other or staggered from one another.

According to one embodiment, the energy absorption assembly is formed as follows. A reinforced composite web is prepared by pultrusion. An NCF carbon fabric is pulled through a resin wet out bath of a vinyl ester followed by forming of the structure and curing of the resin, then shearing of the cured structure to form a desired reinforced composite web having a plurality of open cells. Expanded polypropylene is subsequently foamed in place within the plurality of open cells to form a plurality of energy absorbing cells retained therein, the plurality of energy absorbing cells and the reinforced composite web comprising a composite structure. The density of the expanded polypropylene foam is controlled to elicit a predetermined distribution profile. A front component is disposed on a front side of the composite structure. A back component is disposed on a back side of the composite structure. Crush members may be joined to the back component, or through the back component into the reinforced composite web, wherein some cells can be configured to act as positioning devices and joining flanges for the crush members.

In certain aspects, the present disclosure contemplates a method of producing an energy absorption assembly. The method comprises introducing or filling a plurality of open cells defined by a reinforced composite web with an energy absorbing material, so as to form a composite structure comprising the reinforced composite web and a plurality of energy absorbing cells retained therein. A front component is then disposed on a front side of the composite structure. A back component is then disposed on a back side of the composite structure. The composite structure, together with the front component and back component, form the energy absorption assembly. In certain variations, the energy absorption assembly forms part of a bumper assembly for a vehicle. In such variations, the back component is attached to a plurality of crush members associated with the vehicle. The reinforced composite web typically comprises a polymeric matrix having a reinforcing material distributed therein. The reinforcing material will typically comprise carbon fibers, glass fibers, and mixtures thereof, but may also include aramid, basalt or natural fibers such as jute or hemp. The reinforced composite web may be formed, in whole or in part, by pultrusion, but may also be formed by compression molding, autoclave molding, vacuum molding, resin transfer molding, structural resin transfer molding, or other composite molding techniques. The energy absorbing material may be selected from the group consisting of expanded polypropylene, expanded aluminum, hybridized polyethylene/polyolefin resin, balsa wood, and mixtures thereof. The energy absorbing material may be formed in situ in the plurality of open cells and may be formed using expansion of polypropylene beads. Alternatively, the energy absorbing material may be formed to fit into each of a plurality of open cells and inserted into the applicable open cell. In some variations, the plurality of cells each has a uniform shape and a uniform volume. In yet other variations, the uniform shape is a shape consisting of trapezoids, triangles, squares, rectangles, parallelograms, hexagons, and the like. In other variations, the plurality of cells does not have a uniform shape and a uniform volume. The plurality of cells may resemble, for example, a web like structure. In yet other variations, the thickness of the plurality of cells may not be uniform. Therefore, in some variations, the plurality of cells comprises a first cell having a first volume and a second cell having a second volume, wherein the first volume is distinct from the second volume. In yet other variations, a first cell may be filled with a first energy absorbing material and a second cell may be filled with a second energy absorbing material distinct from the first energy absorbing material. Thus, the energy absorbing material may have different energy absorbing characteristics from cell to cell. This can be achieved by different densities of foam or balsa wood, or by changing the material used cell-to-cell, or by changing the orientation of directional materials such as the honeycombs. In many such variations, when a force is applied to a front side of the energy absorption assembly, the force is distributed across the energy absorption assembly along a predetermined distribution profile. In yet other variations, there is at least one open cell not having the energy absorbing material disposed therein.

In other aspects, the present disclosure contemplates a light-weight energy absorption assembly. The light-weight energy absorption assembly includes a reinforced composite web that defines a plurality of open cells, at least one of which is filled with a light-weight energy absorbing material. The reinforced composite web and filled plurality of cells together define a composite structure. A front component is disposed on a front side of the composite structure. A back component is disposed on a back side of the composite structure. The composite structure, together with the front component and the back component, form the light-weight composite energy absorption assembly. The light-weight energy absorption assembly has properties such that a force applied to the front plate is distributed across the light-weight energy absorption assembly along a predetermined distribution profile. In certain variations, the energy absorption assembly forms part of a bumper assembly for a vehicle. In such variations, the back component is attached to a plurality of crush members associated with the vehicle. The reinforced composite web typically comprises a polymeric matrix having a reinforcing material distributed therein. The reinforcing material will typically comprise carbon fibers, glass fibers, and mixtures thereof, but may also include aramid, basalt or natural fibers such as jute or hemp. The reinforced composite web may be formed, in whole or in part, by pultrusion, but may also be formed by compression molding, autoclave molding, vacuum molding, resin transfer molding, structural resin transfer molding, or other composite molding techniques. The energy absorbing material may be selected from the group consisting of expanded polypropylene, expanded aluminum, hybridized polyethylene/polyolefin resin, balsa wood, and mixtures thereof. The energy absorbing material may be formed in situ in the plurality of open cells and may be formed using expansion of polypropylene beads. Alternatively, the energy absorbing material may be formed to fit into each of a plurality of open cells and inserted into the applicable open cell. In some variations, the plurality of cells each has a uniform shape and a uniform volume. In yet other variations, the uniform shape is a shape consisting of trapezoids, triangles, squares, rectangles, parallelograms, hexagons, and the like. In other variations, the plurality of cells does not have a uniform shape and a uniform volume. The plurality of cells may resemble, for example, a web like structure. In yet other variations, the thickness of the plurality of cells may not be uniform. Therefore, in some variations, the plurality of cells comprises a first cell having a first volume and a second cell having a second volume, wherein the first volume is distinct from the second volume. In yet other variations, a first cell may be filled with a first energy absorbing material and a second cell may be filled with a second energy absorbing material distinct from the first energy absorbing material. Thus, the energy absorbing material may have different energy absorbing characteristics from cell to cell. This can be achieved by different densities of foam or balsa wood, or by changing the material used cell-to-cell, or by changing the orientation of directional materials such as the honeycombs.

In yet other aspects, the present disclosure contemplates a method of producing an energy absorption assembly. The method comprises introducing or filling a plurality of open cells with an energy absorbing material so as to form a composite structure comprising the reinforced composite web and a plurality of energy absorbing cells. A front component is then disposed on a front side of the composite structure. A back component is then disposed on a back side of the composite structure. The energy absorption assembly has properties such that a force applied to the front plate is distributed across the energy absorption assembly along a predetermined distribution profile. In certain variations, the energy absorption assembly forms part of a bumper assembly for a vehicle. In such variations, the back component is attached to a plurality of crush members associated with the vehicle. The reinforced composite web typically comprises a polymeric matrix having a reinforcing material distributed therein. The reinforcing material will typically comprise carbon fibers, glass fibers, and mixtures thereof, but may also include aramid, basalt or natural fibers such as jute or hemp. The reinforced composite web may be formed, in whole or in part, by pultrusion, but may also be formed by compression molding, autoclave molding, vacuum molding, resin transfer molding, structural resin transfer molding, or other composite molding techniques. The energy absorbing material may be selected from the group consisting of expanded polypropylene, expanded aluminum, hybridized polyethylene/polyolefin resin, balsa wood, and mixtures thereof. The energy absorbing material may be formed in situ in the plurality of open cells and may be formed using expansion of polypropylene beads. Alternatively, the energy absorbing material may be formed to fit into each of a plurality of open cells and inserted into the applicable open cell. In some variations, the plurality of cells each has a uniform shape and a uniform volume. In yet other variations, the uniform shape is a shape consisting of trapezoids, triangles, squares, rectangles, parallelograms, hexagons, and the like. In other variations, the plurality of cells does not have a uniform shape and a uniform volume. In yet other variations, a first cell may be filled with a first energy absorbing material and a second cell may be filled with a second energy absorbing material distinct from the first energy absorbing material. Thus, the energy absorbing material may have different energy absorbing characteristics from cell to cell. This can be achieved by different densities of foam or balsa wood, or by changing the material used cell-to-cell, or by changing the orientation of directional materials such as the honeycombs. The plurality of cells may resemble, for example, a web like structure. In yet other variations, the thickness of the plurality of cells may not be uniform. Therefore, in some variations, the plurality of cells comprises a first cell having a first volume and a second cell having a second volume, wherein the first volume is distinct from the second volume. In yet other variations, there is at least one open cell not having the energy absorbing material disposed therein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of producing an energy absorption assembly, the method comprising:
introducing an energy absorbing material comprising expanded polypropylene into a plurality of open cells defined by a web, so as to form a composite structure comprising the web and a plurality of energy absorbing cells retained therein;
disposing a front component on a front side of the composite structure; and
disposing a back component on a back side of the composite structure, so as to form the energy absorption assembly.

2. The method of claim 1, wherein the energy absorption assembly forms part of a bumper assembly for a vehicle and the method further comprises attaching the back component of the composite structure to a plurality of crush members associated with the vehicle.

3. The method of claim 1, wherein the web is a reinforced composite web comprising a polymeric matrix having a reinforcing material distributed therein, where the reinforcing material is selected from the group consisting of: carbon fibers, glass fibers, aramid, basalt, natural fibers including jute, hemp, and bast fibers, and mixtures thereof.

4. (canceled)

5. The method of claim 1, wherein each respective open cell of the plurality of open cells has a uniform shape and a uniform volume.

6. The method of claim 1, wherein the introducing includes filling the plurality of open cells with a precursor of the energy absorbing material.

7. The method of claim 1, wherein prior to the introducing, preforming the energy absorbing material to form a plurality of pre-formed cells dimensioned so as to fit within the plurality of open cells.

8. The method of claim 1, wherein a force applied to the front component is distributed across the energy absorption assembly along a predetermined distribution profile.

9. A light-weight energy absorption assembly comprising:
a web formed by pultruding a non-crimp carbon fabric (NCF) through a resin wet out bath comprising a vinyl ester and defining a plurality of cells at least one of which is filled with a light-weight energy absorbing material so as to define a composite structure, wherein the plurality of cells includes cells with different shapes or different volumes;
a front component attached to a front side of the composite structure; and
a back component attached to a back side of the composite structure, so as to form the light-weight energy absorption assembly, wherein a force applied to the front component is distributed across the light-weight energy absorption assembly along a predetermined distribution profile.

10. (canceled)

11. The light-weight energy absorption assembly according to claim 9, wherein the light-weight energy absorbing material is selected from the group consisting of: expanded polypropylene, expanded aluminum, hybridized polyethylene/polyolefin resin, balsa wood, and combinations thereof.

12. (canceled)

13. The light-weight energy absorption assembly according to claim 9, wherein the light-weight energy absorption assembly forms part of a bumper assembly for a vehicle, wherein the back component of the composite structure is attached to a plurality of crush members associated with the vehicle.

14. The light-weight energy absorption assembly according to claim 9, wherein the plurality of cells are arranged in at least two rows and there are greater than or equal to 10 cells and less than or equal to 20 cells defining the composite structure.

15. A method of producing a composite energy absorption assembly, the method comprising:
filling at least one of a plurality of open cells defined by a web formed by pultruding a non-crimp carbon fabric (NCF) through a resin wet out bath comprising a vinyl ester with an energy absorbing material comprising expanded polypropylene so as to form a composite structure comprising the web and at least one energy absorbing cell;
disposing a front component on a front side of the composite structure; and
disposing a back component on a back side of the composite structure so as to form the energy absorption assembly, wherein a force applied to the front component is distributed across the composite energy absorption assembly along a predetermined distribution profile.

16-17. (canceled)

18. The method of claim 15, wherein the web comprises flats and chains that are separately formed and joined together.

19. The method of claim 15, wherein the web comprises flats and chains that are integrally formed as a single structure.

20. The method of claim 15, wherein the filling of at least one of the plurality of open cells is with a precursor of the energy absorbing material so as to form the at least one energy absorbing cell.

21. The method of claim 1, wherein the expanded polypropylene has a density ranging from about greater than or equal to about 1.8 to less than or equal to about 14 pounds per cubic foot.

22. The method of claim 9, wherein the plurality of cells includes cells with different shapes or different volumes.

23. The method of claim 9, wherein the web comprises flats and chains that are separately formed and joined together.

24. The method of claim 15, wherein the energy absorption assembly forms part of a bumper assembly for a vehicle and the method further comprises attaching the back component of the composite structure to a plurality of crush members associated with the vehicle.

25. The method of claim 15, wherein each respective open cell of the plurality of open cells has a uniform shape and a uniform volume.
